(19) United States
(12) Patent Application Publication
(10) Pub. No.: US 2015/0115632 A1
(43) Pub. Date: Apr. 30, 2015

(54) BUMPER BEAM WITH ROD REINFORCED FACE

(71) Applicant: Shape Corp., Grand Haven, MI (US)

(72) Inventor: Atsushi Iino, Takasaki-Shi-Gunma-Ken (JP)

(21) Appl. No.: 14/464,080

(22) Filed: Aug. 20, 2014

Related U.S. Application Data
(60) Provisional application No. 61/898,119, filed on Oct. 31, 2013.

(51) Int. Cl. B60R 19/18; G06F 17/50; B62D 65/00

(52) U.S. Cl. CPC B60R 19/18; B62D 65/00; G06F 17/50; B60R 2019/1813
USPC 293/120; 703/8

(57) ABSTRACT

A bumper includes a bumper beam having a length and a primary front face forming an impact surface with at least one longitudinal channel formed therein. A rod is positioned in the channel and secured to the bumper beam, with the rod supporting side walls forming the channel. Upon impact, the rod supports the side walls of the channel from thin wall buckling. Thus, the material thickness of the beam can be decreased substantially (and concurrently a total weight decreased) while still maintaining a total force/deflection curve and optimal bending force of the beam.

This application claims priority under 35 USC section 119(e) of U.S. Provisional Patent Application Ser. No. 61/898,119, filed on Oct. 31, 2013, entitled BUMPER BEAM WITH ROD REINFORCED FACE, the entire disclosure which is hereby incorporated by reference in its entirety.

### BACKGROUND

The present invention relates to vehicle bumper beams having a reinforcement for improved impact strength, and to related methods of manufacture.

Bumpers require a balance between weight and performance. An ideal system provides the desired performance and yet has been optimized for low weight. Different designs, manufacturing processes, and materials can produce similarly performing bumpers, but the cost and weight will dictate which bumper is used in mass production. Roll-formed steel tubular bumpers have gained widespread use due to the fact that they can meet performance requirements, are inexpensive when compared to competing manufacturing processes and material cost, and produce a final design system that on a weight-per-performance basis are very attractive. However, current styling trends and the competitiveness in the automotive industry continue to require every possible marginal change that offers cost savings and/or that reduces weight. These factors have pushed the design envelope of roll-formed steel tubular bumpers.

One way that vehicle designers have attempted to reduce bumper weights is to use steel having higher strength and thinner wall sections. However, the bumper impact results achieved are sometimes not as good as desired, since bumper beams with thinner wall sections undergo a phenomenon called “thin wall buckling”, where upon impact, the beam catastrophically fails sooner than expected due to the thin walls kinking and failing sooner than theoretically predicted and with less energy absorption than desired.

Sometimes stiffeners are added to simple roll-formed steel tubular bumpers such as by adding a hat-shaped channel across a center of a bumper beam. These stiffeners are placed to increase beam stiffness at particular locations for the various impacts encountered and tested on bumpers. However, these stiffeners add weight and cost, and can complicate the manufacturing process. The challenge remains to develop bumper beams with stiffeners shaped, positioned, and attached so as to produce a final design that is optimized for weight, cost, and performance.

Thus, a system having the aforementioned advantages and solving the aforementioned problems is desired.

### SUMMARY OF THE PRESENT INVENTION

In one aspect of the present invention, a bumper includes a bumper beam having a length and a primary impact surface with at least one longitudinal channel formed therein. A rod is positioned at least partially in the channel and secured to the bumper beam.

In another aspect of the present invention, a bumper comprises a tubular beam having a length and an outer wall, the outer wall having a primary impact surface with at least one longitudinal channel formed therein; and an elongated solid rod positioned at least partially in the channel and secured to the beam.

In another aspect of the present invention, a method related to the above is provided for designing a bumper system. The method includes designing a first bumper reinforcement beam having a length and a face forming a primary impact surface with at least one longitudinal channel formed in the face; determining an impact strength of the first bumper reinforcement beam by one of computer simulation or physical testing; and designing and producing a second bumper reinforcement beam having a same shape as the first bumper reinforcement beam, but including attaching at least one solid rod in the at least one longitudinal channel, and including reducing a wall thickness of material forming the bumper beam, to thus achieve a reduced total weight of the second bumper reinforcement beam with rod attached while also maintaining an impact strength of the second bumper reinforcement beam that is at least as high as the first bumper reinforcement beam.

These and other aspects, objects, and features of the present invention will be understood and appreciated by those skilled in the art upon studying the following specification, claims, and appended drawings.

### BRIEF DESCRIPTION OF DRAWINGS

FIGS. 1-2 show front perspective and cross sectional views of a bumper beam embodying the present invention.

FIGS. 3-4 show front perspective and cross sectional views of a second embodiment, FIGS. 3-4 being similar to FIGS. 1-2.

FIGS. 5-6 show a first graph of force deflection curve (i.e. load versus impact stroke) and a second graph of beam bending curve (i.e. stroke versus time of stroke).

FIGS. 7-8 show a beam with channels in its face similar to FIGS. 3-4 but without rods in the channels, for comparison against the beam in FIGS. 3-4.

### DETAILED DESCRIPTION OF PREFERRED EMBODIMENTS

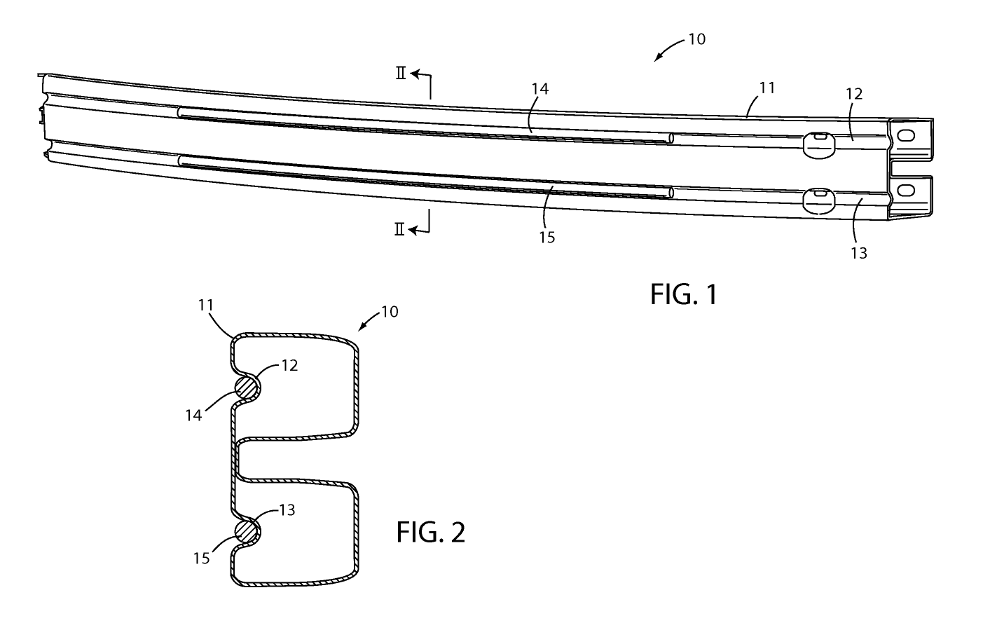

A bumper 10 includes a swept tubular beam 11 having a length and a primary front face forming an impact surface with longitudinal channels 12, 13 formed therein. Rods 14, 15 are positioned in the channels 12, 13 and secured to the bumper beam 11, with the rods 14, 15 each supporting side walls forming the respective channels 12, 13. Upon impact, the rod in each channel supports the walls of the channel from thin wall buckling. This allows the material thickness of the beam 11 to be decreased substantially (and concurrently a total weight decreased) while still maintaining a total force/deflection curve and while still maintaining a desired bending force of the beam 11. Thus, the present invention is a bumper 10 incorporating a type of stiffener (and the process of affixing the stiffener) that optimizes the design for weight, cost, and performance. The illustrated bumper 10 (FIG. 1) includes a roll-formed B-shaped tubular beam 11 with two parallel longitudinal channels 12, 13 in its front wall, and having a pair of solid metal rods 14 and 15 placed therein. However, it is contemplated that the present inventive concepts are not limited to only a B-shaped beam 11, or to only solid metal rods 14, 15, or to only two channels 12, 13. More specifically, the illustrated beam 11 has a B shaped cross section defining two spaced-apart tubes, but it is contemplated that the present innovation can be used on beams defining a single tube (called “D” beams), beams defining a double tube with common center leg (called “mono-leg” beams), or open section beams (such as “C” or “T” or “X” or “W” cross sectional shapes).

The illustrated rods 14, 15 (also called “stiffeners” or “reinforcers”) are made of mild steel, are attached to the front face of the steel tubular bumper beam 11. As illustrated, they are inset fully into the channels 12, 13 so that they do not protrude beyond a face surface of the beam 11. The rods 14, 15 are formed or purchased in straight lengths, and are cut into rod segments having a length shorter than the beam (i.e. cut to a desired length selected to stiffen a center portion of the beam 11, such as 50%-80% of its length, or more preferably about ⅔^{rd} of its length). The rods 14, 15 can be assembled to the beam as straight rod segments or can be deformed into a curved shape prior to assembly to match a curved shape of the beam. Alternatively, it is contemplated that the rods 14, 15 can be resiliently flexed and assembled onto the swept (curved) front face of the beam system in a compressed/tensioned state (preferably where the untensioned rods are more curved than the beam, but optionally where the untensioned rods are straighter than the beam), thus potentially assisting with beam strength during an impact. When in position, the rods 14, 15 support the side walls and bottom wall forming the channels 12, 13, thus stabilizing the walls against thin wall buckling. The rods 14, 15 can be strategically welded or otherwise secured (e.g. brazed or adhered) at locations along the length of the beam 11. The weld locations can be at a minimum of locations, such as at both ends and in a center of the beam. Alternatively, the weld can be continuous along lengths of the rods 14, 15. Optimally, the rods are non-tubular (i.e. have a solid cross section) and are made of mild steel (such as 40 ksi tensile strength, or other structural material such as polymer or composite material), and the bumper beam 11 is made from a much higher strength grade of steel (HSLA, UHSS, or AUHSS), such as 120 ksi or higher tensile strength steel. However, it is contemplated that the rods could in some applications be tubes fully set into the channels 12, 13, and/or that they can be only partially inset into the channels, or that they can be fully inset with a gap to the front face surface. The illustrated rods 14, 15 have a diametrical shape that fully and continuously engages a bottom of the channels 12, 13, but it is contemplated that, in some forms of the present invention, the rods 14, 15 could have a different shape than the channels 12, 13, and/or not continuously engage a bottom of the channels 12, 13 (such as when an adhesive fills any void between the rods and channels).

On impact, an impacting object makes contact with the front surface of the illustrated beam 11 and simultaneously with the rods 14, 15. The bumper 10 may have an energy absorber and a fascia forward of the beam 11 rods 14, 15, but their contribution in absorbing energy is different and provides a relatively lesser amount of energy absorption. Upon impact into the bumper 10, the beam 11, and rods 14, 15 are loaded and will begin to deform. This deformation absorbs some of the initial impact energy. As impact loading increases, the rods 14, 15 will continue to deform, causing the curvature of the roll-formed beam and the rods 14, 15 to decrease. Also, the rods 14, 15 increasingly support the walls forming the channels 12, 13, to prevent premature thin wall buckling. This results in a delay of any catastrophic collapse and failure of the beam 11. Restated, the beam 11 with rods 14, 15 has a much improved and more consistent force/deflection curve and beam bending strength than beams without said channels 12, 13 and rods. Our testing shows that the beam 11 with channels 12, 13, and rods 14, 15 have impact characteristics that are much closer to theoretical values (as compared to a similar beam with channels but without rods, see FIG. 6). For example, the beam 11 (FIG. 4) with rods 14, 15 may be 80%-95% of theoretical bending strength of the beam 11, while the beam 50 (FIG. 8) may only be 70%-80% of the theoretical bending strength. See FIG. 6 which shows a 5%-10% difference.

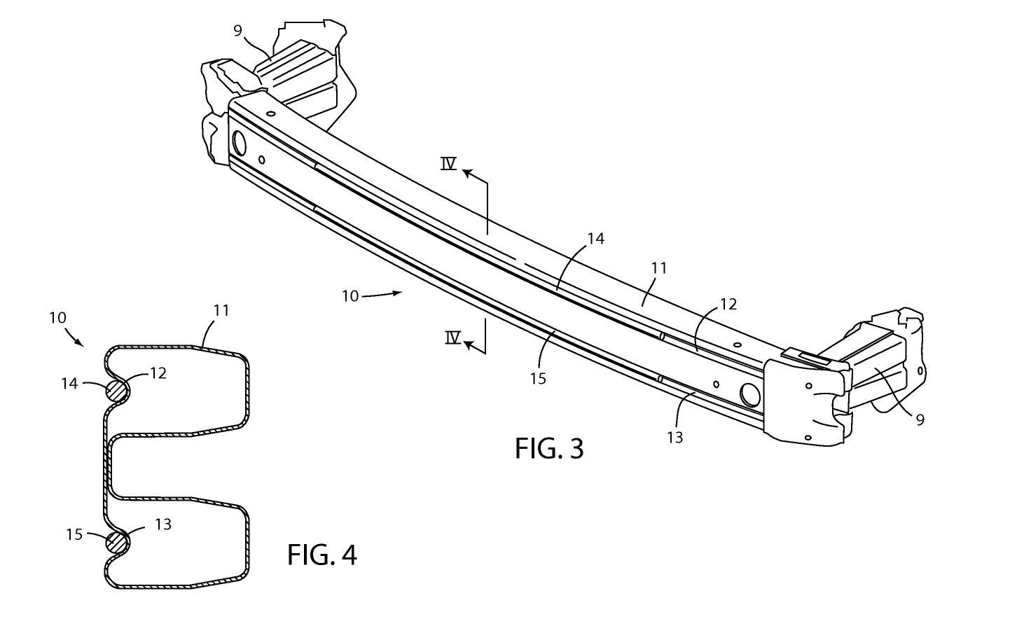

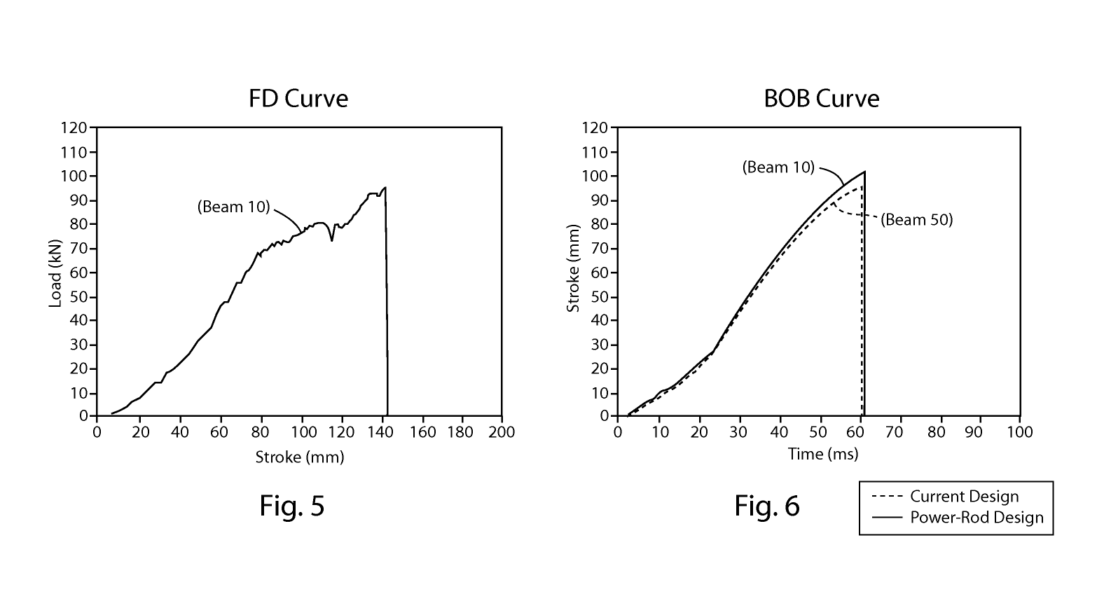

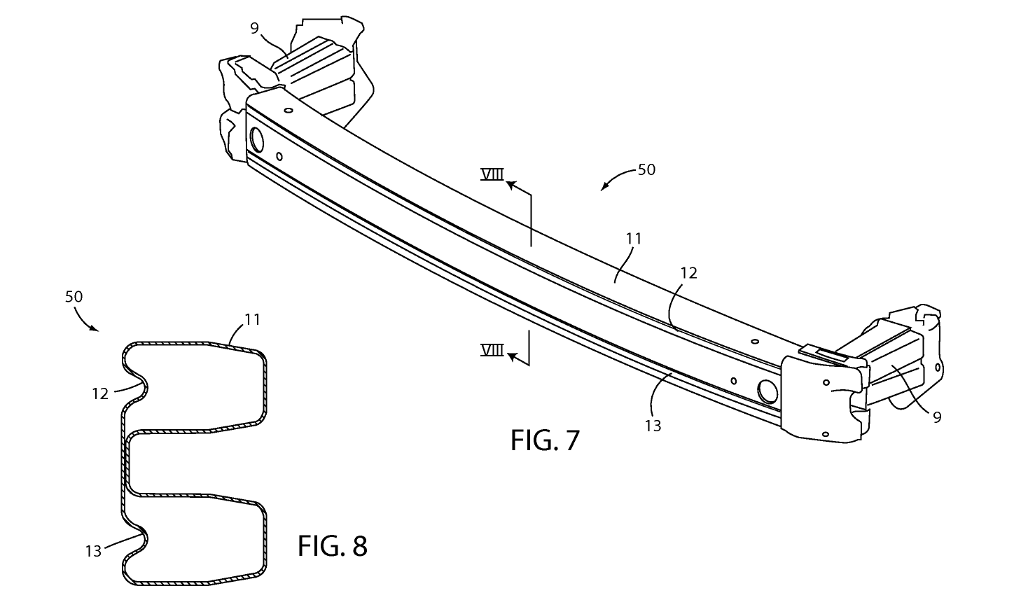

FIGS. 3-6 illustrate the present innovation. For comparison, a beam 50 (FIGS. 7-8) was constructed having a double-tube B-shape similar to beam 11 (FIG. 3-4). However, beam 50 (FIGS. 7-8) was made from steel material having a thickness of 1.2 mm and material tensile strength of 1300 MPa and a cross section of 100×57 mm size and mass of 4.031 kg. Beam 11 (FIGS. 3-4) was made from steel material having a thickness of 0.9 mm and material tensile strength of 1700 MPa and cross section of 100×57 mm size. The rods 14, 15 had a material S45C, thickness of 8 mm diameter, and were adhered in place. The total mass of the beam 11 and rods 14, 15 was 3,496 kg. Thus, beam 11 with rods 14, 15 had a mass savings of 10 percent over the beam 50 (without rods), yet an equal force/deflection curve (FIG. 6) and equal (or slightly greater) beam bending strength over time (FIG. 7). Without the rods 14, 15, the beam 11 (with thinner material of 0.9 mm wall thickness) would prematurely fail and not be satisfactory. With the beam 11 and rods 14, 15 (FIGS. 5-6), the system provides desired force/deflection curves and beam bending strengths. The net effect is that the beam 11 can be provided with a reduced wall thickness and, even with the additional weight of the rods 14, 15, can provide a lower weight total system yet with equal (or higher) load/deflection curve (FIG. 5) and equal (or higher) beam bending strength (FIG. 6).

An advantage in using mild straight length rods is that no secondary processing is needed to bend the rods to a radius that matches the roll-formed bumper beam. The straight rods can be either purchased (potentially as a commodity item) or can be manufactured using various manufacturing techniques. It is contemplated that the decision to purchase or manufacture the tubing will be made based on cost justification and weight considerations. (i.e. The beam 11 weight can potentially be reduced by using a thinner sheet if the rods 14, 15 are added.) The final part will have to be cut to length for the specific application. The secondary process used to attach the rods to the front face of the roll-formed bumper beam may require welding or the use of “glue” and/or structural adhesive minimize heat input into the beam, and clamping fixtures that will place and bend the rods around the front face of the roll-formed bumper beam. Below is a step-by-step process needed to manufacture the reinforced bumper.

Beam 11 is made from HSLA, UHSS, or AUHSS material roll-formed with two radial valleys 12, 13 that run the full length of the beam. The beam 11 is placed in a secondary weld or adhesive application, fixture that will weld on bracket attachments if necessary and will attach the rods 14, 15. The rods are purchased, cut to length, and welded or glued into the rolled pockets/channels in the beam. The illustrated rods 14, 15 are centered on the beam 11 in the cross-car position, and extend about half a length of the beam in both longitudinal directions.

If desired, the rods 14, 15 are formed to a radius that is slightly less (tighter curvature) than the curvature of the bumper beam 11. This allows the rods to rest on the tangents of the radii that are formed in the front face of the roll-formed bumper beam. Welds are spaced to draw load from outboard ends of beams on contact against a flat barrier (i.e. upon a simulated impact). Typical attachment placement would include the ends of the rods and the center of the rods, or continuously if required.

A method related to the above is provided for designing a bumper system. The method includes designing a first bumper reinforcement beam having a length and a face forming a primary impact surface with at least one longitudinal channel formed in the face; determining an impact strength of the first bumper reinforcement beam by one of computer simulation or physical testing; and designing and producing a second bumper reinforcement beam having a same shape as the first bumper reinforcement beam, but including attaching at least one solid rod in the at least one longitudinal channel, and including reducing a wall thickness of material forming the bumper beam to achieve a reduced total weight of the second bumper reinforcement beam with rod attached while also maintaining an impact strength of the second bumper reinforcement beam that is at least as high as the first bumper reinforcement beam.

It is to be understood that variations and modifications can be made on the aforementioned structure without departing from the concepts of the present invention, and further it is to be understood that such concepts are intended to be covered by the following claims unless these claims by their language expressly state otherwise.

The embodiments of the invention in which an exclusive property or privilege is claimed are defined as follows:

1. A bumper apparatus comprising:
a bumper beam having a length and a face forming a primary impact surface with at least one longitudinal channel formed therein; and
at least one solid rod positioned at least partially in the at least one channel and secured to the bumper beam.

2. The bumper defined in claim 1, wherein the at least one solid rod is positioned entirely within the at least one channel and does not protrude out of the at least one channel.

3. The bumper defined in claim 1, wherein the bumper beam is made of a first metal and the at least one rod is made of a second metal having a different tensile strength than the first metal.

4. The bumper defined in clam 3, wherein the bumper beam is tubular.

5. The bumper defined in claim 1, wherein the primary impact surface is curved longitudinally, and the at least one rod has a similar longitudinal curvature.

6. The bumper defined in claim 1, wherein the at least one rod extends a distance less than half the length of the primary impact surface.

7. The bumper defined in claim 1, wherein the channel has a cross section that includes an arcuate section, and the cross section of the at least one rod has a mating arcuate shape.

8. The bumper defined in claim 1, wherein the at least one channel includes first and second channels that extend parallel each other, and wherein the at least one rod includes first and second rods each positioned in the first and second channels, respectively.

9. The bumper defined in claim 8, wherein the rods are tubular and not a solid cross section and are made from high strength steel having a tensile strength of at least 120 KSI.

10. The bumper defined in claim 1, wherein the beam has a constant cross section along a majority of a length of the beam.

11. A bumper comprising:
a tubular beam having a length and an outer wall, the outer wall defining a primary impact surface with at least one longitudinal channel formed therein; and
an elongated solid rod positioned at least partially in the channel and secured to the beam.

12. A bumper comprising:
a beam having an outer wall defining a first curvature; and
at least one rod having a second curvature different from the first curvature when in an unstressed state, but which is resiliently flexed to a stressed state to match the first curvature and which is attached to the outer wall to reinforce the beam.

13. The bumper defined in claim 12, wherein the rod is non-tubular and made of metal.

14. The bumper defined in claim 12, wherein the rod is tubular.

15. A method of designing a bumper system comprising:
designing a first bumper reinforcement beam having a length and a face forming a primary impact surface with at least one longitudinal channel formed in the face;
determining an impact strength of the first bumper reinforcement beam by one of computer simulation or physical testing;
designing and producing a second bumper reinforcement beam having a same shape as the first bumper reinforcement beam, but including attaching at least one solid rod in the at least one longitudinal channel, and including reducing a wall thickness of material forming the bumper beam to achieve a reduced total weight of the second bumper reinforcement beam with rod attached while also maintaining an impact strength of the second bumper reinforcement beam that is at least as high as the first bumper reinforcement beam.
